(19) United States
(12) Patent Application Publication
(10) Pub. No.: US 2012/0113501 A1
(43) Pub. Date: May 10, 2012

(54) ELECTRONIC DISPLAY

(76) Inventors: Jong-Souk Yeo, Corvallis, OR (US); Michael G. Groh, Albany, OR (US); Pavel Kornilovich, Corvallis, OR (US)

(21) Appl. No.: 13/383,980

(22) PCT Filed: Oct. 8, 2009
(86) PCT No.: PCT/US2009/059982

§ 371 Date: Jan. 13, 2012

(51) Int. Cl. G02F 1/167

(52) U.S. Cl. 359/296

(57) ABSTRACT

One embodiment is an electronic display that includes plural reservoirs, two spaced electrodes, and a plural colorant disposed between the two spaced electrodes. Colorants in the plural colorant move between the two spaced electrodes and into the plural reservoirs when subject to an electric field.

### FIELD OF THE INVENTION

The present invention relates to an electronic display that uses plural colorants.

### BACKGROUND

Electronic paper (also referred to as e-paper) is a form of display technology designed to produce visible images that have a similar appearance to printed paper.

An electrophoretic display is one example of e-paper and generally uses electrophoresis to move charged particles in an electrophoretic medium under the influence of an external electric field. The charged particles may also be rearranged in response to changes in the applied electric field to produce visible images.

### BRIEF DESCRIPTION OF THE DRAWINGS

FIG. 1A shows an electronic device with an electronic display in accordance with an example embodiment.

FIG. 1B shows basic internal architecture of the electronic device of FIG. 1A in accordance with an example embodiment.

FIG. 2A shows a top view a display having a multi-level stacking configuration with a matrix of display elements disposed on each of a plurality of structures in accordance with an example embodiment.

FIG. 2B shows a side view the display having a multi-level stacking configuration with a matrix of display elements disposed on each of a plurality of structures in accordance with an example embodiment.

FIG. 3 shows a first embodiment of a display element in accordance with an example embodiment.

FIG. 4 shows a second embodiment of a display element in accordance with an example embodiment.

FIG. 5 shows a third embodiment of a display element in accordance with an example embodiment.

FIG. 6 shows a fourth embodiment of a display element in accordance with an example embodiment.

FIG. 7 shows a fifth embodiment of a display element in accordance with an example embodiment.

FIG. 8 shows a sixth embodiment of a display element in accordance with an example embodiment.

FIG. 9 shows a seventh embodiment of a display element in accordance with an example embodiment.

FIG. 10 shows an eighth embodiment of a display element in accordance with an example embodiment.

FIG. 11 shows a ninth embodiment of a display element in accordance with an example embodiment.

FIG. 12 shows a tenth embodiment of a stacked architecture of a display element in accordance with an example embodiment.

### SUMMARY OF THE INVENTION

One embodiment is an electronic display that includes plural reservoirs, two spaced electrodes, and a plural colorant disposed between the two spaced electrodes. Colorants in the plural colorant move between the two spaced electrodes and into the plural reservoirs when subject to an electric field.

### DETAILED DESCRIPTION

Example embodiments relate to systems, methods, and apparatus that use plural colorants to achieve color in an electronic display, such as an electro-optical display. It is expected that the plural colorants will usually consist of only two different colored colorants (i.e., dual colorants) and, thus embodiments are described with reference to dual colorants as specially defined below. Embodiments, however, are not necessarily limited to dual colorants. The dual colorant mixture includes two oppositely charged colorants that are stably dispersed in an ink or other suitable liquid medium. Since the colorants are oppositely charged, they can be controlled with application of an electric field. In one embodiment, each colorant is independently controlled with gate and/or other electrodes arranged in the structure. Multiple structures are stacked on top of each other to form a full color reflective display.

### DEFINITIONS

As used herein and in the claims, the following words are defined as follows:

The term “dual colorant” is a mixture of two oppositely charged colorants that exhibit two different colors and are contained within a single cell or display element. The colorants move in response to an electric field (positive or negative bias). Each colorant has a different charge (i.e., the colorants of the first color are charged positively, and the colorants of the second color are charged negatively). The term “plural colorant” is a mixture of two or more charged colorants that exhibit two or more different colors with different charges. For example, if the mixture includes three different colored colorants then two of the three colorants will have the charge of the same polarity and the same or different magnitude, and the third colorant will have the charge of the opposite polarity. Application of an electric field separates oppositely charged colorants. Ink is an example of a liquid containing colorants, such as pigments or dyes, that may be used as a dual colorant or, more generally as a plural colorant, as defined above.

The term “electronic paper” or “e-paper” or “electronic ink display” is a display that mimics appearance of ordinary ink on paper without using backlight to illuminate pixels. An electrophoretic display is an example of e-paper.

The term “electro-optical display” is an information display that forms visible images using one or more of electrophoresis, electro-convection, electrochemical interactions, and/or other electrokinetic phenomena. The term “electro-optical display” is used interchangeably with the term “electrokinetic display.”

The term “electrophoretic display” is an information display that forms visible images by rearranging charged colorants using an applied electric field.

The term “electrophoresis” is the motion of dispersed colorants relative to a fluid under the influence of an electric field. The dispersed colorants have an electric surface charge on which the electric field exerts an electrostatic force.

In electrophoresis, charged colorants move in response to an electric field. For example, in response to an electric field, a cell having oppositely charged white and black colorants will move its white or black colorant to a surface of the display depending on the polarity of the colorant (i.e., whether white and black are positively or negatively charged).

One embodiment is an electro-optical display that uses multiple independent structures or display elements that are stacked together. Two, three, four, or more structures can be stacked on top of each other. Each independent structure has one or more transparent conductive layers, one or more transparent substrate layers, and one or more transparent dielectric layers. The structures are transparent to allow light to pass from a top structure to a bottom structure in the stack. The structures are stacked upon each other to provide a multi-color electro-optical display.

In one example embodiment, when no voltage is present across the structure, the colorants are uniformly distributed through the volume of the solvent in which the colorants reside. Here, the appearance of the cell is determined by the optical characteristics of the colorants. When the colorants are collected in the reservoirs, the cells turn clear and appear with color according to the next structure or a reflector below the given structure.

One example embodiment uses one or more of four different colors of cyan, magenta, yellow, and black (CMYK) as the primary subtractive colors or one or more of four different colors of red, green, blue, and white (RGBW) as the primary additive colors or the mixture of both for the dual colorants. As used herein, a transparent state is also considered a color state. These colors are arranged in the multi-level stack configurations of the structures to produce any shade of color throughout the visible spectrum using the primary colors.

One example embodiment is a multi-level stack configuration that uses four different structures stacked on top of each other. Each structure is provided with one of the four colors of cyan, magenta, yellow, and black (CMYK). The electric fields across each stack level are individually controlled to enable different shades of cyan, magenta, yellow, and black to occur at a respective level. By mixing cyan, magenta, yellow, and black and different shades or intensities of these colors at the respective levels, the electro-optical display achieves various colors.

Another embodiment is a multi-level stack configuration that uses two different structures stacked on top of each other. Each structure is provided with two of the four colors of cyan, magenta, yellow, and black. Each dual colorant contains two colors (i.e., two of cyan, magenta, yellow, and black). For example, the first structure contains dual colorants with cyan and yellow, and the second structure contains dual colorants with magenta and black.

In the embodiment using two structures, each colorant is provided with a separate reservoir. In other words, one set of reservoirs is designated for cyan; one set of reservoirs is designated for magenta; one set of reservoirs is designated for yellow; and one set of reservoirs is designated for black.

In one embodiment, the reservoirs are systematically distributed according to color.

As one example of this systematic distribution, reservoirs on one side of the structure are all designated for one color; and reservoirs on another, opposite side of the structure are designated for a second color. By way of illustration, assume the first structure has colorants with the two colors of magenta and yellow, and the second structure has colorants with two colors of cyan and black. In the first structure, reservoirs on one side are temporarily designated for collecting or displaying magenta, while reservoirs on the opposite side of the structure are designated for collecting or displaying yellow. In the second structure, reservoirs on one side are temporarily designated for collecting or displaying cyan, while reservoirs on the opposite side of the structure are designated for collecting or displaying black.

As another example of this systematic distribution, each structure includes a first set or series of reservoirs designated for a first colorant and a second set or series of reservoirs designated for a second colorant. By way of illustration, assume the first structure has colorants with the two colors of magenta and yellow, and the second structure has colorants with two colors of cyan and black.

Although example embodiments are discussed using four different colors (cyan, magenta, yellow, and black), other example embodiments can use more or less colors, different color combinations, and/or combinations of these four colors with other colors (such as red, green, blue, white, etc.).

Once the dual colorants are collected in reservoirs, the colorants are electrostatically locked inside the reservoirs with a gate electrode which is passivated. Once the color is locked in the reservoirs, colorants collected and/or locked for the other color can be released. For example, assume a dual colorant has charged colorants of black and magenta. An electric field is applied to collect black colorants in designated reservoirs (for example, one side of the structure). These black colorants are locked in the reservoirs using a gate electrode. The magenta color colorants can be collected and locked in their designated reservoirs (for example, a second opposite side of the structure) using gate electrodes. The black colorants (or only a portion of the black colorants) can then be released from their reservoirs while the magenta colorants (or only a portion of the magenta colorants) remain locked in their respective reservoirs. Both colorants can be compacted at the same time to each side to achieve a clear state, or one particle can be independently compacted to provide the color from dispersed colorants.

Example embodiments lock and release dual colorants to achieve different colors and different shades of colors. Example embodiments are able to lock all dual colorants or only portions of such colorants. In other words, example embodiments can lock from 0% to 100% of each color of the dual colorants. For example, to obtain a certain color, 50% of magenta colorants are collected and locked, while 10% of black colorants, 20% of yellow colorants, and 7% of cyan colorants are collected and locked.

Collecting, locking, and releasing of dual colorants is independently controlled for each respective particle type in a respective structure. In other words, cyan colorants are independently controlled from magenta, black, or yellow colorants that may exist in the structure; magenta colorants are independently controlled from cyan, black colorants, or yellow colorants that may exist in the structure; black colorants are independently controlled from magenta, cyan, or yellow colorants that may exist in the structure; and yellow colorants are independently controlled from magenta, black, or cyan colorants that may exist in the structure.

One embodiment is an electro-optical display that does not use a backlight. Instead, light incident on the display is reflected to illuminate the display. The structures are transparent so light incident on a first or top structure can travel to subsequent or lower structures.

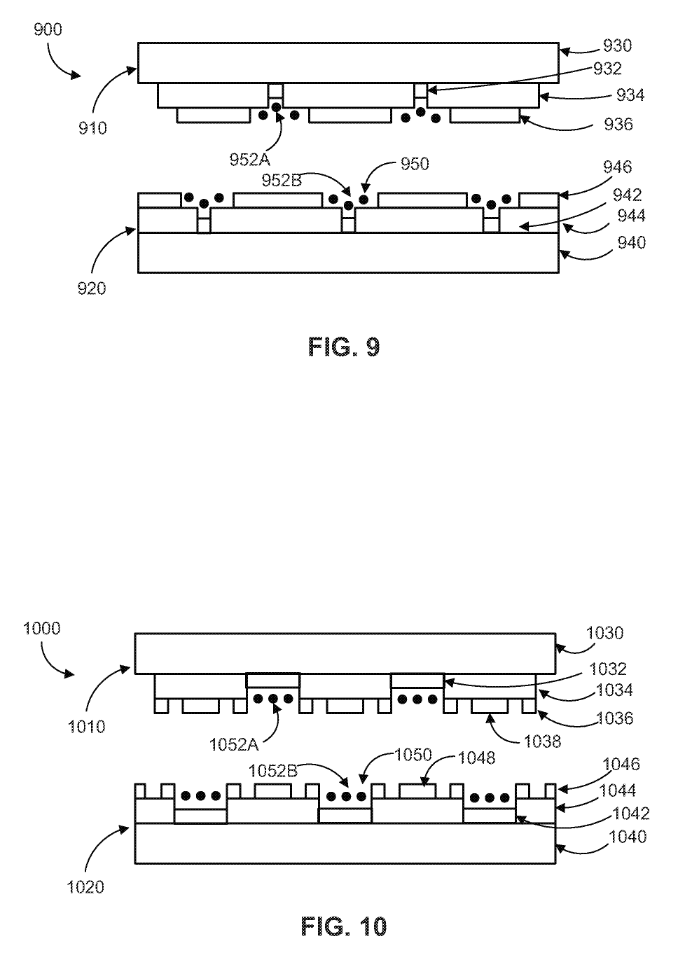

Example embodiments can control the gray scale using various methods. For example, one method to control gray scale is actively driven gray scale (such as shown in FIG. 9 with opposing electrodes), and another method is passively driven gray scale (such as shown in FIG. 8 with gate electrodes). Modulating the pulse width or pulse amplitude can also be used to achieve and control gray scale in actively driven gray scale.

One example embodiment independently controls multiple colorants by using an electro-optical architecture with gate electrodes on a same plane or distal electrodes on opposite planes.

Example embodiments achieve a transparent state that enables structures to be stacked to provide color displays with high contrast and brightness. A dual electro-optical architecture reduces the number of structures and provides improved control of colorants within the stack. Even for electronic skin applications with singly charged colorants, this provides additional functionality as colorants compact to the dot arrays or reservoirs on top or bottom structures at either polarity.

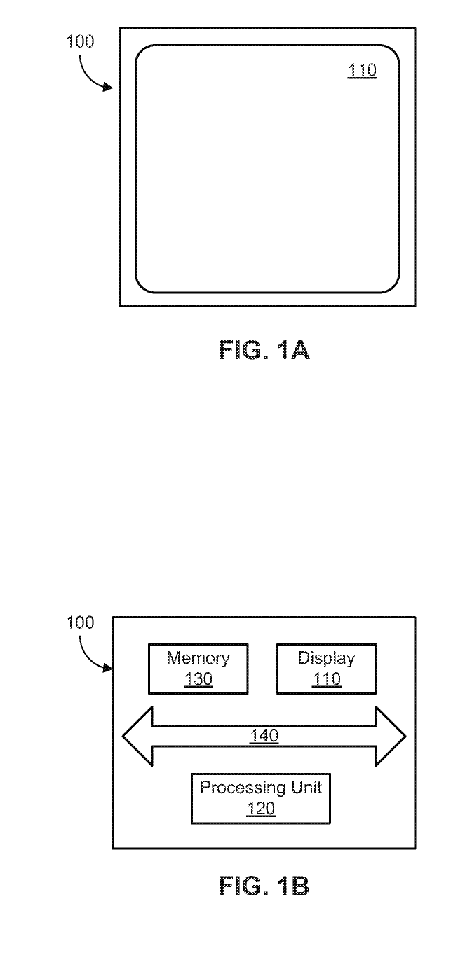

FIGS. 1A and 1B show an electronic device 100 with a color display 110, such as an electro-optical display. The electronic device includes a processing unit 120, such as a central processing unit (CPU), an application specific integrated circuit (ASIC), a microcontroller, etc. Memory 130 stores data, instructions, and/or programs and includes random access memory (RAM) for temporary data storage and/or read only memory (ROM) for permanent data storage. A communication link or bus 140 couples the processor to the memory and display.

Although example embodiments discuss the electronic display as an electro-optical display, such embodiments are not limited to any particular type of electronic device or an electrokinetic display. Example embodiments include, but are not limited to, portable and non-portable computers, portable and non-portable electronic devices, electronic newspapers, e-books, watches/clocks, digital photo frames, smart cards, cellular phones, and other electronic devices with a display.

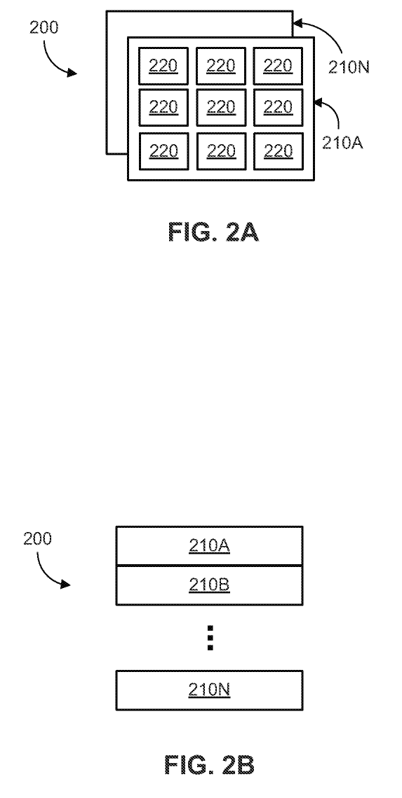

FIGS. 2A and 2B show an electronic display 200 having a multi-level stacking configuration with a matrix of display elements 220 disposed on each of a plurality of structures 210A, 210B, to 210N in accordance with an example embodiment. Each structure includes one or more display elements, and example embodiments are not limited to any number of stacked structures. For example, two, three, etc. structures can be vertically stacked together.

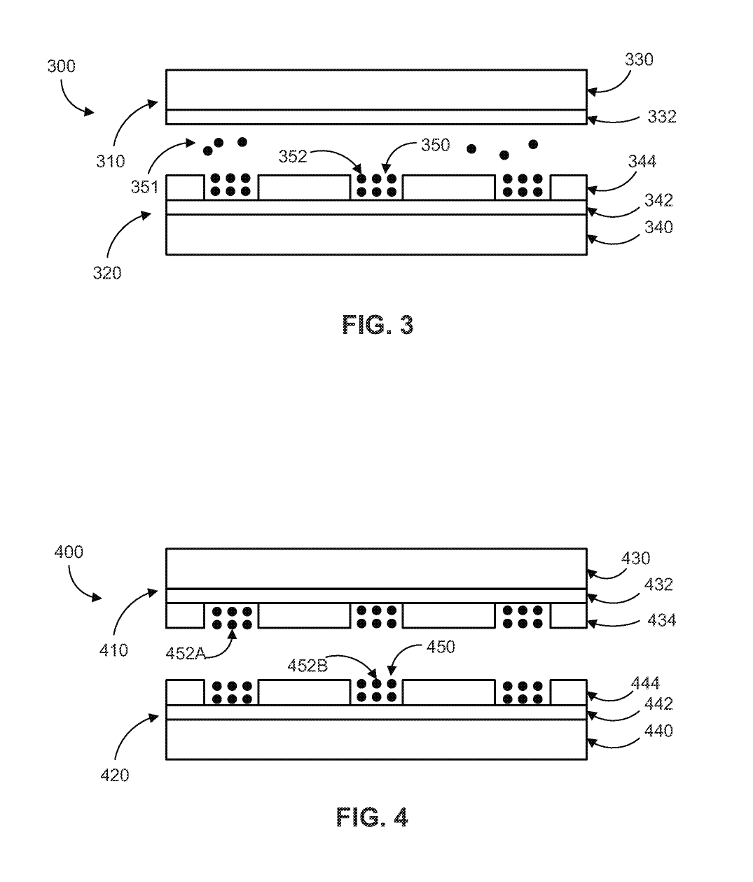

The display 200 includes passively addressed matrix of display elements or actively addressed matrix of display elements. Examples of the display elements 220 are shown in FIGS. 3-11. Further examples are shown in two patent applications: “Electro-Optical Display” filed on Mar. 26, 2009 having U.S. Ser. No. 12/411,828; and entitled “A Display” filed on Apr. 30, 2009 having PCT serial number PCT/US2009/042404, both applications being incorporated herein by reference.

In example embodiments, the electro-optical display 200 generally includes at least one display element 220 established on a surface of a substrate. As shown in the FIGS. 3-11, each display element includes at least two opposed parallel electrodes and at least one reservoir, hole, or trench disposed between the opposed electrodes. Some embodiments also include gate electrodes. The opposed electrodes and the reservoir(s) are arranged in a manner sufficient to enable in-plane motion of dual colorants present in an electrically activatable liquid medium. Such in-plane motion generally occurs in response to a sufficient electric potential (i.e., electric field) applied to the dual colorants by one or more of the electrodes.

FIG. 2 shows the display elements 220 arranged on the substrates in a two-dimensional array, where the display elements are disposed in straight lines to form a substantially square lattice. Other arrangements of the display elements include, but are not limited to, arrangements in rectangular lattices, substantially triangular lattices, or stretched triangular lattices.

The display elements 220 are stacked in two or more levels or structures on substrates to form “multi-level stacking.” Such multi-level stacking arrangements enable colored images to be produced by the display 200.

The display elements 220 are arranged in rows and columns to form a matrix. In other embodiments, the display elements 220 are provided as individual segments having one or more display elements. In any event, each element 220 or segment of elements is/are generally driven by at least two electrodes that form an electric field.

As shown in FIGS. 3-11, the electrodes in the display elements can be arranged in a wide variety of configurations to form an electro-optical display or other type of electronic display. Generally, these configurations include one or more substrates, one or more dielectrics, and multiple electrodes (such as one or more of a first electrode at one level, a second electrode at another level, and a gate electrode) arranged in a multi-level stacking arrangement. The embodiments in FIGS. 3-11 can be used as one or more of the structures 210A-210N shown in FIGS. 2A and 2B.

As one example, substrates with an electro-optical architecture (line or dot structures opened in a dielectric layer on top of patterned or blanket conductive layers) are separated by containment walls and placed on opposite sides to produce dual electro-optical display architecture. Also, dual electro-optical displays with gate electrodes are fabricated by placing gate electrodes on opposing sides with containment walls in-between.

As another example, a dual electro-optical display architecture without gate electrodes includes a patterned or blanket conductive layer that is connected and controlled electrically to allow compaction of oppositely charged colorants. Dual electro-optical displays with gate electrodes where each gate electrode and blanket or patterned electrodes are connected and controlled electrically allows independent control of grey scale in each colorant. This occurs by controlling the relative potential between gate and reservoir electrodes.

As yet another example, electrodes in dual electro-optical displays are passivated with a thin dielectric layer on top. Dual electro-optical displays without gate electrodes have distal electrodes fabricated on an opposing side and controlled electrically to allow the amount of charged colorants that can spread out of reservoirs based on the relative potential between the reservoir electrode and the distal electrode. Passive or active addressing is applied to control movement of charged colorants.

Further examples include dual electro-optical displays with single colorants that provide a clear state at both polarities of the opposing electrodes and a dark (or spreading) state when there is no bias or in-between the pulses of applied bias. Dual electro-optical displays can be directly driven, passive matrix or active matrix driven. Dual electro-optical displays can have the reservoirs of various shapes, geometries, arrangements to optimize the electrokinetic or electro-optical behavior of the charged colorants.

FIG. 3 shows a first example of a display element 300 that includes a top layer 310 and a bottom layer 320. The top layer 310 includes a substrate 330 on which an electrode 332 is mounted. As used herein, the term “mount” or “mounted” includes coated, deposited, fabricated or other techniques. The bottom layer 320 includes a substrate 340 on which an electrode 342 and a dielectric layer 344 are mounted. Recesses 350 are formed in the dielectric layer 344 to store dual colorants 352 having two oppositely charged colorants. One colorant is shown at 352 in a recess or reservoir 350, and another colorant is shown at 351 in a dispersed state. By way of example, optical states can alter between magenta and black with one colorant being positively charged and the other colorant being negatively charged (i.e., the colorants 351 and 352 are oppositely charged from each other).

FIG. 4 shows a second example of a display element 400 that includes a top layer 410 and a bottom layer 420. The top layer 410 includes a substrate 430 on which an electrode 432 and dielectric 434 are mounted. The bottom layer 420 includes a substrate 440 on which an electrode 442 and a dielectric layer 444 are mounted. Recesses 450 are formed in the dielectric layers 434 and 444 to store dual colorants 452A and 452B having two oppositely charged colorants. One colorant is exhibited on one side of the substrate, while another colorant is exhibited on the other side of the substrate. For example, colorants 452A are positively charged magenta, and colorants 452B are negatively charged black. By way of example, the optical states can alter between clear and mixed states of black and magenta.

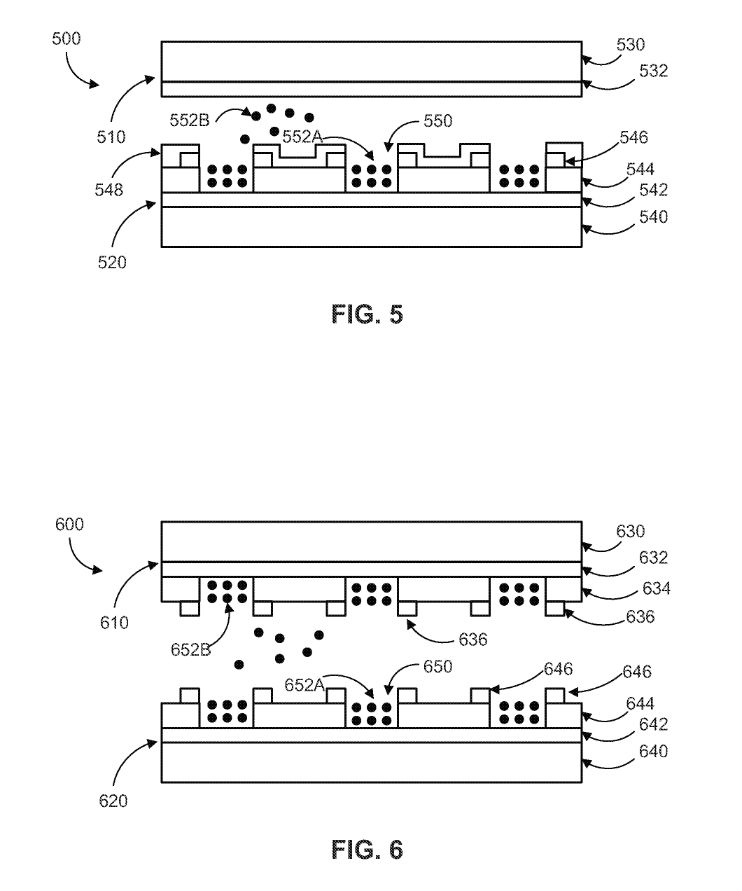

FIG. 5 shows a third example of a display element 500 that includes a top layer 510 and a bottom layer 520. The top layer 510 includes a substrate 530 on which an electrode 532 is mounted. The bottom layer 520 includes a substrate 540 on which an electrode 542, a dielectric layer 544, a plurality of gate electrodes 546, and a passivation layer 548 are mounted. Recesses 550 are formed in the dielectric layer 544 to store one colorant 552A while the other colorant 552B is in a dispersed state. By compacting one colorant completely and controlling the amount of that colorant in the display element volume, gray scale of that colorant can be achieved. Optical state changes from one color of the dual colorants to another color of dual colorants as the colorants move into and out of the reservoirs. By way of example, if the two colorants are magenta and black, then example optical states would include colors of a black with 0 to 100% magenta or magenta with 0 to 100% black.

FIG. 6 shows a fourth example of a display element 600 that includes a top layer 610 and a bottom layer 620. The top layer 610 includes a substrate 630 on which an electrode 632, dielectric 634, and plurality of gate electrodes 636 are mounted. The bottom layer 620 includes a substrate 640 on which an electrode 642, a dielectric layer 644, and a plurality of gate electrodes 646 are mounted. Recesses 650 are formed in the dielectric layers 634 and 644 to store dual colorants 652A and 652B having two oppositely charged colorants. Gray scale of both colorants and a clear state are achieved by independently controlling each colorant from each side. As such, one embodiment achieves one color or the other color, or the mixed color as well as a transparent state which allows stacking. By way of example, if the two colorants are magenta and black, then example optical states would include colors of 0 to 100% magenta and 0 to 100% black and their mixed states, as well as a transparent state.

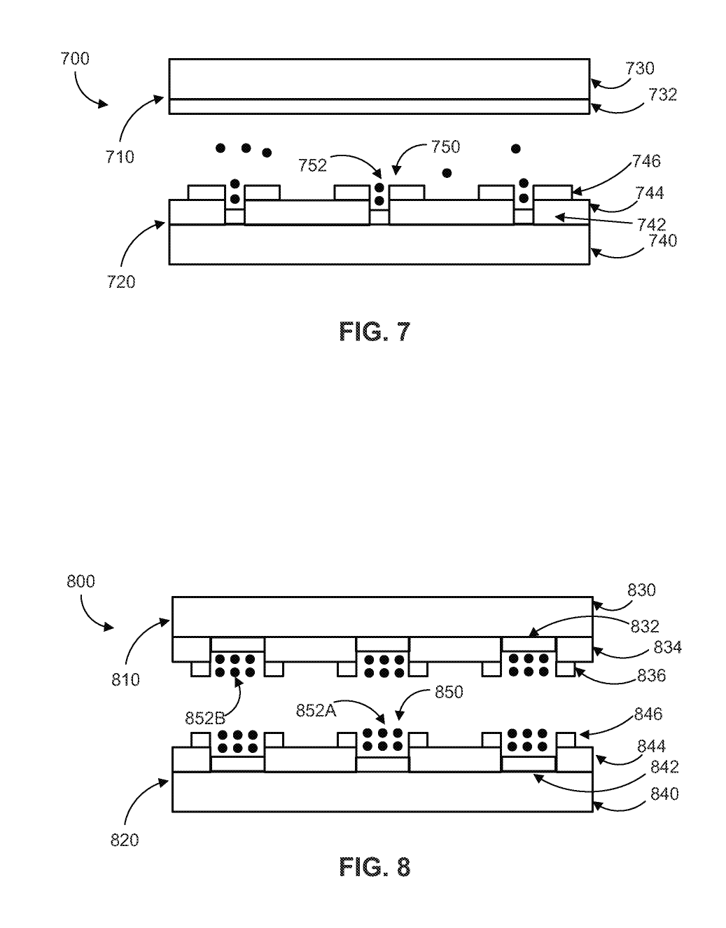

FIG. 7 shows a fifth example of a display element 700 that includes a top layer 710 and a bottom layer 720. The top layer 710 includes a substrate 730 on which an electrode 732 is mounted. The bottom layer 720 includes a substrate 740 on which electrodes 742, a dielectric layer 744, and a plurality of gate electrodes 746 is mounted. Recesses 750 are formed in the dielectric layer 744 to store colorants 752. Here, the electrodes 742 are positioned between a pair of the dielectric material.

FIG. 8 shows a sixth example of a display element 800 that includes a top layer 810 and a bottom layer 820. The top layer 810 includes a substrate 830 on which electrodes 832, a dielectric layer 834, and a plurality of gate electrodes 836 is mounted. The bottom layer 820 includes a substrate 840 on which electrodes 842, a dielectric layer 844, and a plurality of gate electrodes 846 is mounted. Recesses 850 are formed in the dielectric layers 834 and 844 to store dual colorants 852A and 852B. Here, the electrodes 832 and 842 are positioned between pairs of the dielectric material.

FIG. 9 shows a seventh example of a display element 900 that includes a top layer 910 and a bottom layer 920. The top layer 910 includes a substrate 930 on which first electrodes 932, a dielectric layer 934, and second electrodes 936 are mounted. The second electrodes 936 are positioned or mounted on a distal end of the dielectric layer 934. The bottom layer 920 includes a substrate 940 on which first electrodes 942, a dielectric layer 944, and second electrodes 946 are mounted. The second electrodes 946 are positioned or mounted on a distal end of the dielectric layer 944. Recesses 950 are formed in the dielectric layers 934 and 944 to store dual colorants 952A and 952B. Here, the electrodes 932 and 942 are positioned between a pair of the dielectric material such that electrodes 932 are oppositely disposed from electrodes 946, and electrodes 936 are oppositely disposed from electrodes 942. Furthermore, in this configuration, the recesses in the top layer 910 are offset from the recesses in the bottom layer 920. By way of example, if the two colorants are magenta and black, then example optical states would include colors of 0 to 100% magenta and 0 to 100% black, as well as a transparent state.

FIG. 10 shows an eighth example of a display element 1000 that includes a top layer 1010 and a bottom layer 1020. The top layer 1010 includes a substrate 1030 on which first electrodes 1032, a dielectric layer 1034, a plurality of gate electrodes 1036, and second electrodes 1038 are mounted. The bottom layer 1020 includes a substrate 1040 on which first electrodes 1042, a dielectric layer 1044, a plurality of gate electrodes 1046, and second electrodes 1048 are mounted. Recesses 1050 are formed in the dielectric layers 1034 and 1044 to store dual colorants 1052A and 1052B. Here, the electrodes 1032 are oppositely disposed from electrodes 1048, and electrodes 1038 are oppositely disposed from electrodes 1042. Furthermore, in this stack configuration, the recesses in the top layer 1010 are offset from the recesses in the bottom layer 1020. By way of example, if the two colorants are magenta and black, then example optical states would include colors of 0 to 100% magenta and 0 to 100% black, as well as a transparent state. The optical states are achieved by passive and active driving. For example, active driving includes sending 30 ms of pulses between the electrodes.

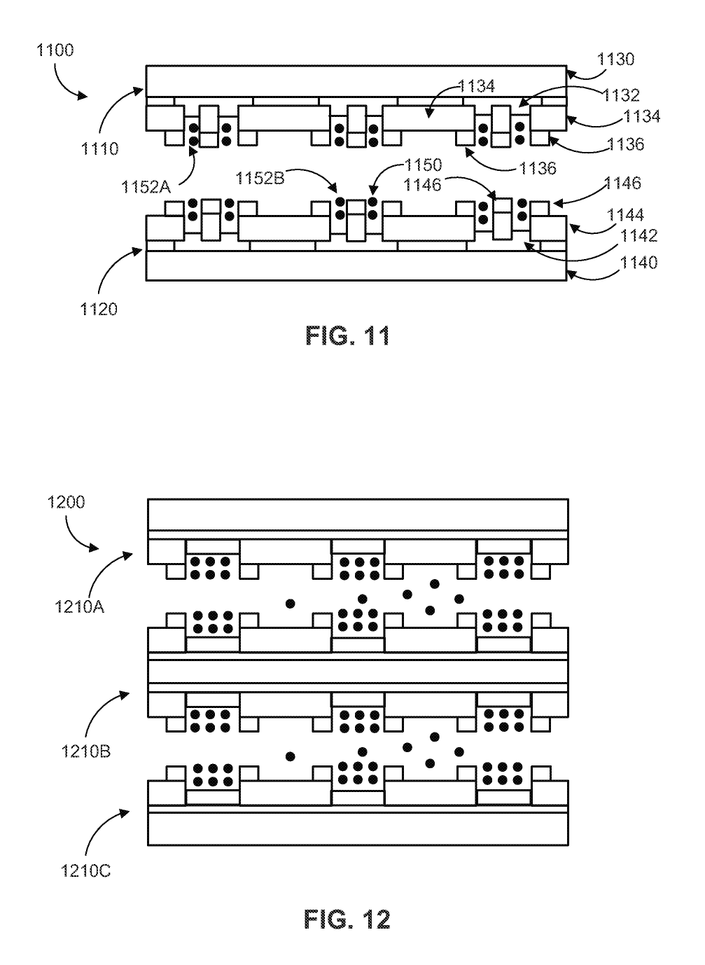

FIG. 11 shows a ninth example of a display element 1100 that includes a top layer 1110 and a bottom layer 1120. The top layer 1110 includes a substrate 1130 on which electrodes 1132, a dielectric layer 1134, and a plurality of gate electrodes 1136 are mounted. The bottom layer 1120 includes a substrate 1140 on which electrodes 1142, a dielectric layer 1144, and a plurality of gate electrodes 1146 are mounted. Recesses 1150 are formed in the dielectric layers 1134 and 1144 to store dual colorants 1152A and 1152B. In this structural configuration, gate electrodes on dielectric material and segmented or pixelated reservoir electrodes are positioned between or in the recesses

FIG. 12 shows a tenth embodiment of a stacked architecture 1200 with multiple structures, such as 1210A, 1210B, and 1210C. As noted, different structures shown in the drawings can be stacked together to achieve full color. Using three primary subtractive colorants full color is achieved with different colorants in different levels being in compacted and dispersed states.

In one example embodiment, one or more blocks or steps discussed herein are automated. In other words, apparatus, systems, and methods occur automatically. The terms “automated” or “automatically” (and like variations thereof) mean controlled operation of an apparatus, system, and/or process using computers and/or mechanical/electrical devices without the necessity of human intervention, observation, effort and/or decision.

The methods in accordance with example embodiments of the present invention are provided as examples and should not be construed to limit other embodiments within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing example embodiments. Such specific information is not provided to limit the invention.

In the various embodiments in accordance with the present invention, embodiments are implemented as a method, system, and/or apparatus. As one example, example embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known physical and tangible computer-readable media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A color electronic display, comprising:
a first structure including plural reservoirs and two spaced electrodes; and
plural colorant disposed between the two spaced electrodes, wherein colorants in the plural colorant move between the two spaced electrodes and into the plural reservoirs when subject to an electric field.

2) The color electronic display of claim 1, wherein the plural colorant comprises a dual colorant that includes two of primary colorants of red, green, blue, and white or cyan, yellow, magenta, and black, or a combination of these colorants.

3) The color electronic display of claim 1 further comprising:
a second structure stacked on the first structure and including plural reservoirs and two spaced electrodes; and
a plural colorant disposed between the two spaced electrodes of the second structure;
wherein the plural colorant of the first structure includes two different color colorants and the plural colorant of the second structure includes two different color colorants each of which is a different color than the colorants of the first structure.

4) The color electronic display of claim 1 further comprising either one or both of gate electrodes operable with one or both spaced electrodes to control the colorants in the plural reservoirs, or distal electrodes disposed on opposite planes and operable to control the colorants.

5) The color electronic display of claim 1, wherein application of a first electric field across the two spaced electrodes in the first structure separates oppositely charged colorants and causes the first structure to have a first color on one side of the first structure and a second color on second side of the first structure opposite the first side.

6) The color electronic display of claim 1, wherein the plural reservoirs are disposed in a dielectric layer along each of the two spaced electrodes.

7) An electronic device, comprising:
a first display element that includes a first layer with a first electrode and first reservoirs to receive first colorants that have a first color and a second layer with a second electrode and second reservoirs to receive second colorants that have a second color different than the first color.

8) The electronic device of claim 7 further comprising:
gate electrodes in the first display element to alternately lock and release the first colorants from the reservoirs in the top and bottom layers.

9) The electronic device of claim 7 further comprising:
a second display element stacked on the first display element and including a first layer with a first electrode and first reservoirs to receive third colorants that have a third color and a second layer with a second electrode and second reservoirs to receive fourth colorants that have a fourth color.

10) The electronic device of claim 7 further comprising a second display element stacked on the first display element, wherein the first display element produces two different colors and the second display element produces two other different colors to provide color light throughout a color space.

11) The electronic device of claim 7, wherein the reservoirs in the first layer of the first display are designated for a first color, and the reservoirs in the second layer of the first display are designated for a second color.

12) A method to generate color in an electronic display, comprising:
applying a first electric field in a first display element to collect a first dual colorant in a first reservoir;
applying a second electric field in a second display element stacked on the first display element to collect a second dual colorant different from the first dual colorant in a second reservoir.

13) The method of claim 12 further comprising:
independently controlling the first and second electric fields to generate different colors at each of the first and second display elements.

14) The method of claim 12 further comprising:
collecting, in a first set of reservoirs in the first display element, colorant exhibiting a first color;
collecting, in a second set of reservoirs in the first display element, colorant exhibiting a second color;
collecting, in a first set of reservoirs in the second display element, colorant exhibiting a third color; and
collecting, in a second set of reservoirs in the second display element, colorant exhibiting a third color.

15) The method of claim 12 further comprising:
applying a third electric field in the first display element to move the first dual colorant out of the first reservoir;
applying a fourth electric field in the second display element to move the second colorant out of the second reservoir.
